(19) United States
(12) Patent Application Publication
(10) Pub. No.: US 2026/0246698 A1
(43) Pub. Date: Aug. 20, 2026

(54) Programmable Multi-Vendor Multi-Layer Resource Adapter

(71) Applicant: Ciena Corporation, Hanover, MD (US)

(72) Inventors: Sandeep Sharma, Faridabad (IN); Rana P. Ghoshal, New Delhi (IN); Shubhankur Manuja, Bharatpur (IN); Harish Chauhan, Jalandhar (IN)

(73) Assignee: Ciena Corporation, Hanover, MD (US)

(21) Appl. No.: 19/095,642

(22) Filed: Mar. 31, 2025

(30) Foreign Application Priority Data
Feb. 14, 2025 (IN) 202541012580

(51) Int. Cl. H04L 41/084; G06F 16/21; G06F 40/117

(52) U.S. Cl. CPC H04L 41/084; G06F 16/211; G06F 40/117

(57) ABSTRACT

Systems and methods for integrating heterogeneous network devices into a network management system via a resource adapter are provided. In an embodiment, a method includes receiving device configuration or state data from a plurality of network devices, each device conforming to a respective vendor-specific YANG schema; performing a first phase of translation on the device configuration or state data via one or more extensible stylesheet language transformations (XSLT) transformations to produce abstract normalized YANG models, the first phase is configured to absorb differences in device behaviors, protocols, and schemas; performing a second phase of translation on the abstract normalized YANG models into an internal schema of the network management system, the second phase remaining consistent across multiple device types in a technology domain; and providing resulting data, structured according to the internal schema, to one or more network management system components.

### FIELD OF THE DISCLOSURE

The present disclosure relates generally to computing. More particularly, the present disclosure relates to systems and methods for a generic extensible stylesheet language transformations (XSLT)-based data driven and programmable multi-vendor multi-layer resource adapter (RA).

### BACKGROUND OF THE DISCLOSURE

In network management, a resource adapter serves as an intermediary software component that facilitates communication and coordination between a central management platform and various network elements—such as routers, switches, servers, and other devices. By translating management commands from the platform into device-specific protocols or data formats, and converting device outputs into a standardized form usable by the platform, a resource adapter isolates the higher-level system from the complexities of diverse, heterogeneous resources. This isolation not only streamlines the process of configuration, provisioning, and monitoring across multiple device types and vendors, but also enhances the scalability and flexibility of network operations. Resource adapters typically handle tasks including protocol negotiation, command validation, and error handling, allowing the central management platform to focus on higher-level orchestration and policy enforcement rather than the intricacies of individual network elements.

However, despite their utility, conventional resource adapters suffer from significant limitations. Existing solutions are hard-coded to cater to specific device types and a limited set of YANG (Yet Another Next Generation) models, and no resource adapter can generically handle arbitrary YANG data in a truly programmable manner. Because many of these resource adapters rely on rigid translations that assume specific device behaviors, they are neither generic nor easily customizable at runtime. Even small changes—such as introducing new device types or adapting to different YANG models—often require a full compile/build cycle, patching, and a process restart, which is both time-consuming and disruptive. As a result, providing customers with a quick estimated time of adoption (ETA) for new device types or updated YANG schemas is difficult, since the required patch-and-deploy approach leads to extended turnaround times. This lack of generic, programmable resource adapters impedes agility and slows the broader evolution of network management solutions.

### BRIEF SUMMARY OF THE DISCLOSURE

The present disclosure relates to systems and methods for a generic, XSLT-based, data-driven, and programmable multi-vendor, multi-layer resource adapter. Specifically, it describes the development of a low-code, programmable, generic YANG-based RA that enables a network management system to function as a multi-vendor, multi-layer controller capable of providing management functions for third-party routers and switches. A key aspect of this approach lies in the use of hand-coded XSLT translations to a normalized model, which allows for easy tuning of the transformations to accommodate different devices and behaviors. Furthermore, the run-time programmability of these XSLTs facilitates dynamic updates without the need for code patches or RA process restarts, thereby offering a significantly reduced estimated time of arrival (ETA) for supporting new devices or vendors. The present disclosure includes a device-agnostic RA that leverages low-code principles and XSLT transformations to support a truly multi-vendor, multi-layer environment. This solution includes (1) the adoption of normalized abstract YANG models that reconcile differences in device behaviors, (2) the use of intuitive XSLT translations to map specific device models to these abstract models, and (3) the integration of programmability through various rules within the existing rule engine in a network management system (NMS). Together, these elements deliver a robust, flexible, and easily customizable platform that can quickly adapt to evolving network environments and emerging device requirements.

In various embodiments, the present disclosure can be implemented through computer‐executable instructions stored on a non‐transitory computer‐readable medium and executed by one or more processors. These instructions configure the processors to perform a computer‐implemented method that integrates heterogeneous network devices into a network management system by way of a resource adapter. Specifically, the resource adapter can automatically discover, poll, and manage devices that operate on different protocols or standards, translating their individual configurations into a unified data model. This ensures that multi‐vendor or legacy devices seamlessly interoperate under a single management framework, allowing operators to monitor, configure, and orchestrate complex network infrastructures in a streamlined manner.

The steps include receiving device configuration or state data from a plurality of network devices, each device conforming to a respective vendor-specific YANG schema; performing a first phase of translation on the device configuration or state data via one or more extensible stylesheet language transformations (XSLT) transformations to produce abstract normalized YANG models, the first phase is configured to absorb differences in device behaviors, protocols, and schemas; performing a second phase of translation on the abstract normalized YANG models into an internal schema of the network management system, the second phase remaining consistent across multiple device types in a technology domain; and providing resulting data, structured according to the internal schema, to one or more network management system components.

The steps can further include dynamically modifying at least one XSLT transformation at runtime, without requiring a system restart, to accommodate changes in device types or feature requirements. The steps can further include storing or caching the abstract normalized YANG models before converting them into the internal schema of the network management system. The steps can further include validating the device configuration or state data against corresponding YANG schema definitions prior to the first phase of translation, and rejecting or logging any data that does not conform. The steps can further include applying one or more rules via a rule engine to dynamically determine which XSLT transformations to invoke for the first phase of translation based on at least one of device type, vendor identifier, software version, or user-defined policies. The internal schema of the network management system can be one of a termination point encapsulation/forwarding relationship encapsulation/network construct/equipment (TPE/FRE/NC/Equipment) model, a software-defined networking (SDN) controller model, an orchestration system model, or a proprietary internal schema.

The one or more XSLT transformations include at least one of merging multiple Extensible Markup Language (XML) paths into a single abstract YANG attribute, splitting a single XML path into multiple abstract YANG attributes, executing conditional logic to accommodate device-specific behaviors, or embedding or invoking scripts in a language other than XSLT. The steps can further include receiving updates to the XSLT transformations via an application programming interface (API) and instructing the resource adapter to use the updated XSLT transformations without requiring a code patch or system restart. The steps can further include implementing session handlers for multiple management protocols, including at least one of Network Configuration Protocol (NETCONF), gRPC Network Management Interface (gNMI), or a command line interface (CLI), to retrieve the device configuration or state data from each network device.

The steps can further include publishing only portions of the abstract normalized YANG models or the internal schema data that are relevant to one or more northbound components of the network management system in order to minimize unnecessary data transmission. The steps can further include merging information from at least two different protocols, including any of Network Configuration Protocol (NETCONF), gRPC Network Management Interface (gNMI), or a command line interface (CLI), into a single abstract YANG attribute prior to the first phase of translation.

The resource adapter can be deployed in a dedicated Java process that executes both phases of translation and communicates the resulting data to the network management system without sharing hardware resources with other processes. The steps can further include providing an option to deliver the abstract normalized YANG models directly to an external operations support system (OSS) or analytics platform, bypassing the second phase of translation for customers desiring device-agnostic data. The steps can further include storing workflow definitions and policy rules in one or more repositories to govern how incoming device data is processed and mapped, thereby enabling non-developer stakeholders to configure or override translation behaviors. The steps can further include incorporating fallback or error-handling mechanisms that revert to a default XSLT transformation when a custom or newly introduced XSLT file fails to produce valid abstract YANG data, for continuous operation.

### BRIEF DESCRIPTION OF THE DRAWINGS

The present disclosure is detailed through various drawings, where like components or steps are indicated by identical reference numbers for clarity and consistency.

FIG. 1 illustrates a logical diagram of a generic, low-code resource adapter (RA) that can support different devices from various vendors in two distinct phases

FIG. 2 illustrates a more detailed view of the functional architecture of the resource adapter (RA) of FIG. 1, illustrating how the RA manages device communications, normalizes data, and ultimately interfaces with a network management system.

FIG. 3 illustrates a conceptual overview of the key features, benefits, and guiding principles of the resource adapter’s (RA) XSLT-based translation framework.

FIG. 4 illustrates a block diagram of a computing system that may be used to realize the RA of FIGS. 1 and 2.

FIG. 5 illustrates a flowchart of a process for integrating heterogeneous network devices into a network management system via a resource adapter.

### DETAILED DESCRIPTION OF THE DISCLOSURE

This disclosure focuses on a low-code, programmable, generic YANG-based multi-vendor, multi-layer resource adapter that enables a network management system to function as a comprehensive, multi-vendor, multi-layer controller. In a multi-vendor context, the resource adapter can manage network devices from various manufacturers or vendors, thereby eliminating the need for multiple, proprietary solutions. Furthermore, its multi-layer capabilities allow it to oversee data across different layers of the network, such as Layer 0 (optical), Layer 1 (time division multiplexing (TDM), Layer 2 (Ethernet), Layer 3 (Internet Protocol (IP)), etc. By leveraging a low-code architecture and advanced XSLT-based transformations, the resource adapter can rapidly adapt to new device behaviors, supporting efficient management functions for a wide array of third-party routers and switches. This design also facilitates runtime programmability, reducing dependencies on time-consuming software patching and restarts. Overall, this disclosure significantly accelerates the integration of new devices, streamlines network operations, and promotes greater flexibility in evolving multi-vendor, multi-layer environments.

Today, resource adapters are tightly coupled to specific devices, making it challenging to support new hardware or software that uses different schemas or protocols. When a new device type is introduced, a separate RA must often be created to translate that device’s data into an internal termination point encapsulation/forwarding relationship encapsulation/network construct/equipment (TPE/FRE/NC/Equipment) of a network management system. This approach does not scale well, particularly in environments that must accommodate multiple vendors and rapidly changing technologies. The problem is exacerbated by three key factors. First, routers from different manufacturers may implement a variety of schema models—some use OpenConfig, others follow Internet Engineering Task Force (IETF) standards, while still others rely on proprietary native models. Second, even devices adhering to the same YANG or OpenConfig models can exhibit distinct behaviors and quirks, which may vary by device family or software version within the same vendor’s product lines. Third, routers may support different management protocols, such as Network Configuration Protocol (NETCONF_ for get/set operations, gRPC (Remote Procedure Call) Network Management Interface (gNMI) for both configuration and streaming telemetry, or a traditional command line interface (CLI)-based interface. Some vendors offer a mix of these protocols—for example, one vendor may support gNMI subscriptions for monitoring state changes, NETCONF for configuration, and CLI for specific use cases. Together, these variations in schemas, behaviors, and protocols highlight the shortcomings of traditional, device-specific RA designs, emphasizing the need for a flexible, generic, and easily scalable approach.

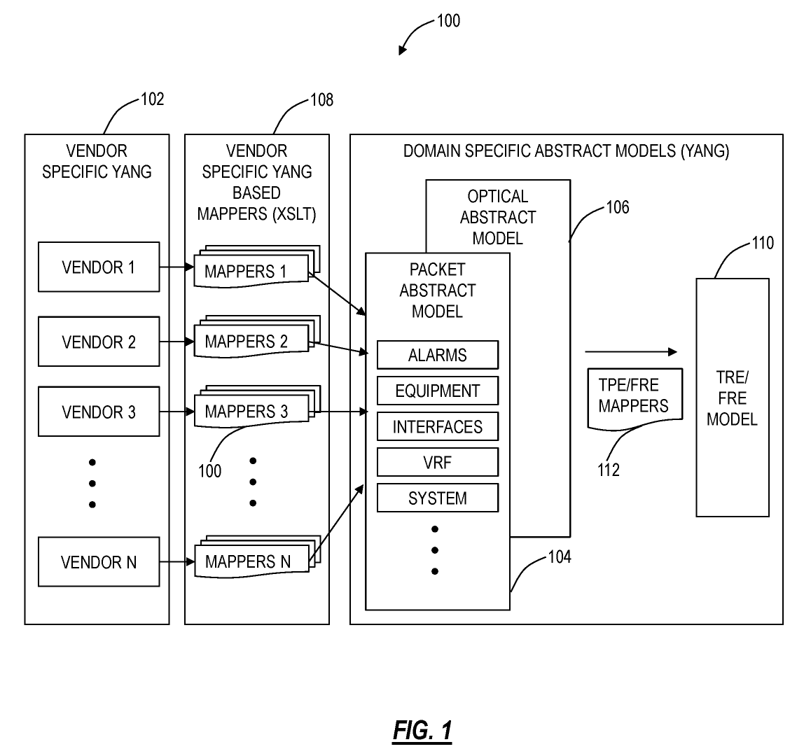

FIG. 1 illustrates a logical diagram of a generic, low-code resource adapter (RA) 100 that can support different devices from various vendors in two distinct phases. As shown on the left-hand side of FIG. 1, there are multiple vendor-specific YANG models 102 for vendors 1, 2, …N. Each vendor may have multiple device families or product lines that rely on diverse YANG schemas (e.g., proprietary native models, OpenConfig, IETF, etc.). The RA 100 leverages an intermediate “normalizing” YANG model to unify these differences in device behavior and schema, thereby enabling a consistent abstraction layer for the network management system. This normalization process is performed during discovery, configuration for provisioning/edit use cases, and data translation, allowing the RA 100 to manage heterogeneous devices more effectively.

Phase 1 involves translating native device data—irrespective of the underlying YANG schema—into one or more abstract normalized YANG models 104, 106. In FIG. 1, the packet abstract model 104 is used for packet-based network devices (e.g., routers, switches), while the optical abstract model 106 is used for optical devices (e.g., ROADMs, optical amplifiers). However, additional abstract models (e.g., wireless) can be introduced as needed to accommodate other technology domains. The translation in this phase is executed via vendor-specific XSLT mappers 108, which offer a data-driven method for converting Extensible Markup Language (XML)-based YANG instances. XSLT is particularly well-suited for complex transformations—such as merging or splitting specific XML paths—as it provides a structured, rule-based approach for manipulating hierarchical data. Each abstract model 104, 106 can include components for alarms, equipment, interfaces, layer-specific protocol entities, system information, and so forth, ensuring that the RA 100 can represent essential operational data for a wide variety of devices.

Phase 2 involves further translating the abstract normalized YANG data into an internal TPE/FRE schema used by the network management system, designated in FIG. 1 as a TRE/FRE model 110. TPE (“termination point encapsulation”) and FRE (“forwarding relationship encapsulation”) are schema constructs specific to the internal architecture of the network management system, in an example embodiment (other types of internal schema are contemplated), enabling the system to represent how various termination points and forwarding paths are provisioned or interconnected. The transformation from the abstract models 104, 106 into the TPE/FRE model 110 is handled by TPE/FRE mappers 112, typically implemented in Java or other compiled languages. Because both the abstract input models (packet model 104, optical model 106, etc.) and the TPE/FRE output model 110 remain constant, the TPE/FRE mappers 112 represent a one-time code development effort that does not need frequent alteration. Consequently, this two-phase approach—vendor-specific YANG-to-abstract model translation in Phase 1, followed by abstract model-to-TPE/FRE translation in Phase 2—ensures a scalable, flexible, and low-code solution for rapidly integrating new vendors, device types, or evolving YANG schemas without disrupting the core network management system. Note, while referred to a TPE/FRE, this can also be a termination point encapsulation/forwarding relationship encapsulation/network construct/equipment (TPE/FRE/NC/Equipment) model, namely an internal model that models the TRE, FRE, NC, and equipment.

Following this approach, once a particular feature is implemented for a specific device type, extending support to a new device type primarily involves creating or updating an XSLT file to translate from the device’s native YANG schema to the abstract model (e.g., the packet or optical abstract models 104, 106). Because these transformations operate entirely on XML representations of YANG data, the individual authoring the XSLT need only be familiar with the device’s domain and YANG models 102. They need not delve into the internal complexities of the TPE/FRE model 110 or microservices, which remain consistent across all devices. By decoupling vendor-specific details from the underlying network management system, this modular design significantly streamlines the process of incorporating new devices—eliminating the need for specialized knowledge of the network manager’s internal architecture or time-consuming code modifications. Ultimately, this results in faster onboarding of new equipment, reduced development effort, and a more adaptable resource adapter framework.

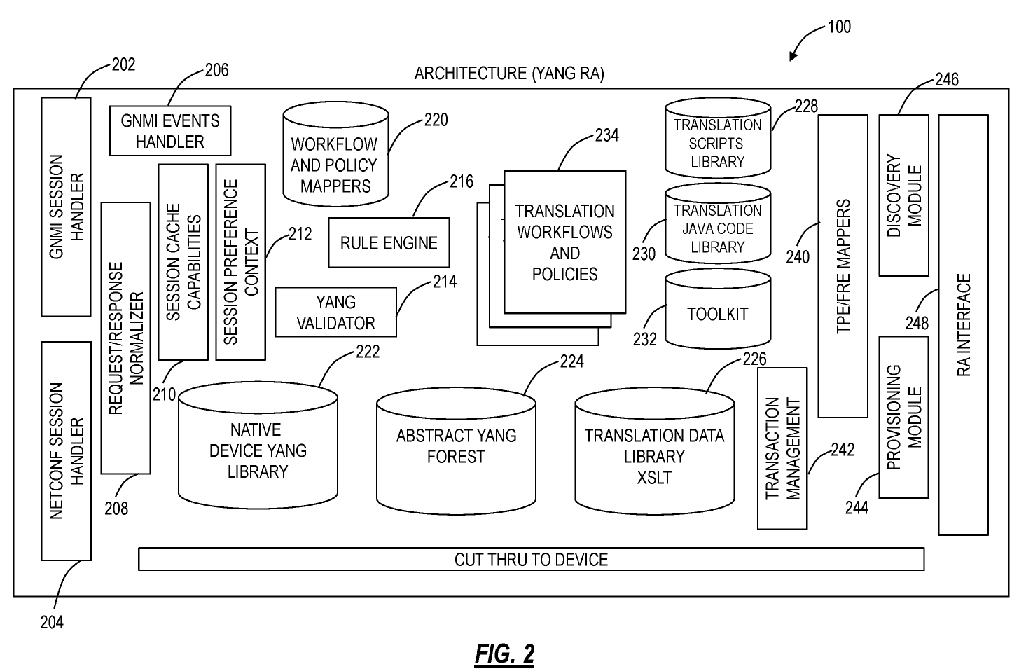

FIG. 2 provides a more detailed view of the functional architecture of the resource adapter (RA) 100, illustrating how the RA 100 manages device communications, normalizes data, and ultimately interfaces with a network management system. From right to left, the first phase of the RA’s operation is shown to include multiple session handlers—namely a gNMI session handler 202, a NETCONF session handler 204, and a gNMI events handler 206—that establish and maintain communication channels with various devices. These session handlers handle different protocol requirements, allowing the RA 100 to retrieve device configurations, status, and event notifications from a wide range of network elements.

After collecting device data, a request/response normalizer 208 converts or adapts that raw information into a standardized format suitable for internal processing. This capability is further enhanced by session cache 210, which stores relevant session data for reuse, and session preference context 212, which records preference rules, user settings, or system defaults that govern how data is retrieved and handled. A YANG validator 214 ensures that all incoming data conforms to the expected YANG schema definitions, thereby safeguarding against schema violations or malformed data. The rule engine 216 applies custom or pre-defined logic—such as configuration policies, business rules, or validation checks—to the normalized data, enabling dynamic behaviors based on network or user requirements.

Various data repositories support these operations. For instance, workflow and policy mappers 220 store mapping instructions and higher-level policies, while the native device YANG library 222 contains vendor-specific or proprietary YANG models. An abstract YANG forest 224 provides modular fragments of the RA’s intermediate, normalized YANG schemas. The translation data library XSLT 226, translation scripts library 228, and translation Java code library 230 collectively house the transformation logic needed to reconcile device-specific data with the RA’s internal structures. To facilitate creation and maintenance of these transformations, a toolkit 232 provides utilities and templates for generating new or updated XSLT rules. Building on these resources, the RA 100 executes translation workflows and policies 234, thereby converting device-native data into the abstract normalized models in a flexible, low-code manner.

In the second phase of processing, TPE/FRE mappers 240 transform the abstract normalized data into the TPE/FRE schema used internally by the network management system. Transaction management 242 ensures consistency and atomicity of operations—coordinating device updates, rollbacks, or error handling as necessary. The provisioning module 244 orchestrates end-to-end configuration tasks across the environment, while the discovery module 246 manages device identification and onboarding. Finally, the RA interface 248 serves as the primary communication point between the RA 100 and the broader network management system, providing an application programming interface (API) or other integration mechanism to request device information, issue configuration changes, and monitor network state.

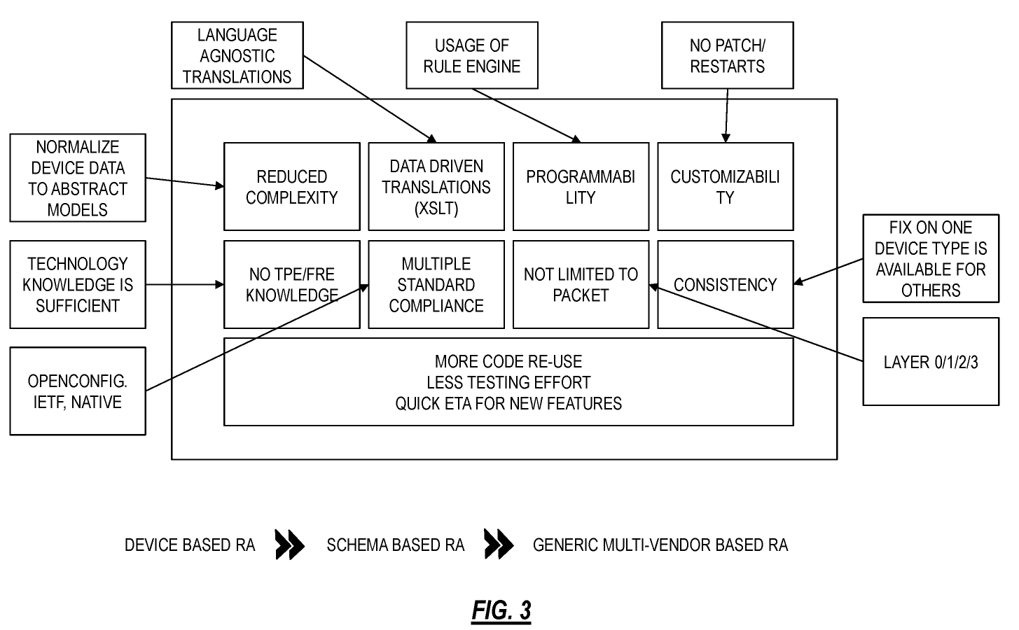

FIG. 3 provides a conceptual overview of the key features, benefits, and guiding principles of the resource adapter (RA) 100’s XSLT-based translation framework. FIG. 3 highlights several core aspects, including language-agnostic translations, use of a rule engine for dynamic updates, and the elimination of patching or restarts when incorporating new device types or features. By normalizing device data to intermediate abstract models, the RA 100 achieves reduced complexity, ensures consistency across multiple network layers (Layer 0/1/2/3), and enables code reuse. FIG. 3 also illustrates how technology expertise—rather than detailed knowledge of the RA’s internal TPE/FRE data structures—suffices for creating or modifying XSLTs to accommodate OpenConfig, IETF, or proprietary native YANG schemas.

As depicted in FIG. 3, the customizable XSLTs and straightforward rule-driven approach confer several advantages:
(a) Genericity: The RA 100’s XSLT mechanism makes the translation logic both straightforward to develop and highly portable. For instance, if a feature is already supported for one device type (e.g., device X), extending the same functionality to another device type (e.g., device Y) primarily requires creating a new XSLT file that references or builds on existing mappings. Authors can merge or split XML paths (xpaths), implement conditional logic, or otherwise refine the transformation rules without altering the RA’s internal architecture. Moreover, XSLT (as provided in standard JDK libraries) is a powerful, language-agnostic tool for XML-to-XML conversions. Anyone familiar with XSLT can contribute by writing these translation rules, effectively treating XSLT as a programming language for orchestrating data transformations.
(b) Customizability: The existing or newly created XSLT can be refined to address specific requirements, especially when multiple vendor devices disperse critical operational data across different YANG schemas. In a multi-vendor environment involving coherent pluggable modules, for example, the RA 100 can determine dynamically whether a pluggable module (“plug”) is ZR or ZR+ by updating XSLTs in real time. This runtime adaptability enables an RA operator to accommodate unique or changing device behaviors without necessitating a full recompilation or system restart. Notably, this represents a low-code implementation: if a feature X is supported on device A, no source code modifications are required to extend that same feature to other devices, regardless of device-specific behaviors, models, or communication protocols. Moreover, new features can be introduced rapidly using the same approach.
(c) Programmability: Once an XSLT file is prepared, it can be deployed for a particular translation task—such as VRF—by updating a rule via Representational State Transfer (REST) APIs. For example, if a new VRF_v1.xslt file is created to address a feature request or bug fix, the RA 100 can be instructed to use VRF_v1.xslt for a specific device family immediately, thus replacing older translation logic without requiring a system patch or process restart. The mappings can also be modified at runtime without any Java code changes, patch installations, or restarts. An internal rule engine is employed for enforcing these runtime adjustments.
(d) Quick ETA: Because the XSLT-based translation framework avoids formal patch cycles and the associated extensive verification processes, the RA 100 can address new feature requests or customer issues rapidly—potentially in hours or days, rather than weeks or months. In multi-vendor environments where device behaviors vary widely, this flexibility significantly expedites onboarding, troubleshooting, and feature rollouts.
(e) Technical Expertise: Critically, the individual authoring these XSLT files does not need to understand the RA’s TPE/FRE internal models. Instead, domain knowledge of the device’s YANG schema (or the abstract model’s YANG schema) is sufficient. This division of responsibilities lowers the barrier to entry for developing or modifying device mappings, thereby increasing scalability and reducing the reliance on specialized system experts.

Together, these attributes underscored in FIG. 3—genericity, customizability, programmability, quick turnaround, and reduced need for specialized expertise—highlight the RA 100’s ability to efficiently manage diverse network devices across multiple layers while simplifying the development, testing, and deployment processes.

In this architecture, minimal involvement from the core design team is required, making the project more akin to an open-source initiative. In addition to design engineers, individuals from pre-sales, accounts, and CRT teams can also contribute, provided they have domain knowledge and understand XML. Because the network management system (TPE/FRE) is hidden behind intermediate (normalized) models, these contributors do not need to learn the internal modeling details or write Java code. Instead, they can focus on mapping device-native YANG data to the abstract models, while the existing Java framework manages the rest of the translation and integration processes.

With respect to traditional resource adapters, the RA 100 offers several notable advantages and features, described as follows:

Two-Stage Mapping Approach: The RA 100 employs a multi-phase process for translating device data. In Phase 1, device-native YANG schemas (whether proprietary, OpenConfig, or IETF-based) are converted into a device-specific abstract or normalized model. In Phase 2, this abstract model is translated into the network management system’s internal TPE/FRE schema (i.e., the model for a network management system). This two-stage process effectively absorbs the differences in device behavior and YANG structure, ensuring that the Java mapping from the abstract model to TPE/FRE is consistent across various devices for the same feature. Critically, the author of these mappings does not need to understand the internal TPE/FRE models, as their focus remains solely on converting device-native YANG data to the abstract YANG representation. As a result, development and testing efforts are significantly reduced—particularly when introducing new devices supporting the same features—since only the device-to-abstract model mapping must be validated. Moreover, there is provision for sending these abstract/normalized models directly to an operations support system (OSS) if desired, thus bypassing TPE/FRE entirely. This may be beneficial for customers interested in normalized device data but not the TPE/FRE model, and is expected to become a prominent use case in the future. Note, the TPE/FRE models are described as an example of an internal model for the network management system—this can be any type of internal schema for a network management system, software defined networking (SDN) controller, orchestration system, etc.

XSLT-Driven Translations: The RA 100 primarily relies on XSLT for executing translations, leveraging the rich set of tools available within the standard JDK XSLT library. In effect, XSLT is treated as a programming language, enabling authors to implement loops, conditions, and other logic constructs directly within the transformations. Furthermore, there is an option to embed Python or other shell scripts if specialized logic or pre/post-processing steps are needed. This flexible approach empowers a wide range of contributors, even those without deep Java expertise, to create and maintain the translation logic.

Self-Contained Java Process (Yang-RA): All translations are encapsulated in a single Java process, which can be referred to as the Yang-RA. This process independently retrieves data from the device, converts that data into the normalized format, and delivers the information to the higher-level components in the network management system, akin to how other resource adapters function. By hosting the RA 100 in its own dedicated process, there is minimal resource contention with other processes, leading to improved stability and manageability.

Optimized Data Flow to Kafka: When publishing data from devices to northbound components within the network management system, only relevant and required information—converted into TPE/FRE format by the Yang-RA—is sent over Kafka. This selective publication strategy helps prevent unnecessary load on Kafka clusters, ensuring that only actionable data is propagated to the higher-level services. Note, those skilled in the art will recognize Kafka is one implementation of a data publishing system; other approaches are contemplated.

Complex Protocol Mappings: A core use case for the RA 100 is the ability to handle complex mappings that draw on multiple protocols for a single attribute. For instance, some parts of an attribute’s data might be retrieved via NETCONF while others come from a CLI session, all of which must be merged into a single YANG attribute before being passed on. The Yang-RA architecture readily supports this scenario, combining and reconciling disparate protocol data sources into a cohesive representation within the abstract model.

### Example Computing System Architecture

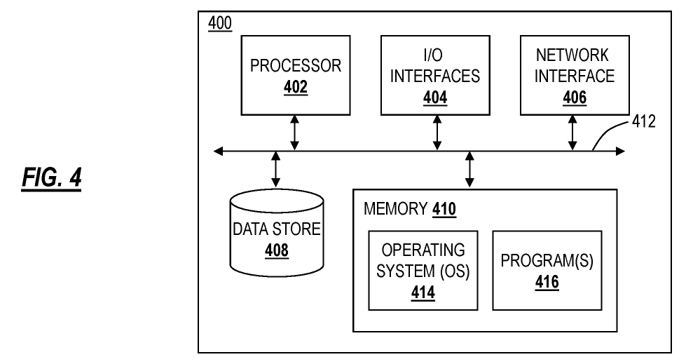

FIG. 4 is a block diagram of a computing system 400 that may be used to realize the RA 100. The computing system 400 can be implemented in many forms, including physical servers, clusters of machines, virtual machines (VMs) running on hypervisors, serverless computing frameworks, or the like. Regardless of the underlying infrastructure, the computing system 400 typically includes one or more processors 402, input/output (I/O) interfaces 404, a network interface 406, a data store 408, and memory 410. Note that FIG. 4 provides a simplified representation; in practice, the computing system 400 may include additional hardware and software elements. These components 402, 404, 406, 408, 410 are connected via a local interface 412, which can include various wired or wireless buses, high-speed interconnects, or switching fabrics. The local interface 412 may also include controllers, buffers, caches, drivers, repeaters, and receivers, along with addressing and control lines that facilitate efficient communication and resource sharing among components.

Each processor 402 is a hardware element—such as a central processing unit (CPU), multicore processor, system-on-chip (SoC), graphics processing unit (GPU), or a processing element within a larger compute cluster—designed to execute software instructions. These processors may be general-purpose or specialized, depending on performance, power efficiency, or workload needs. During operation, each processor 402 retrieves and executes instructions stored in memory 410, manages data exchanges with the data store 408, and oversees system 400 operations. In large-scale environments, multiple processors 402 may operate in parallel to handle elevated traffic and complex workloads.

The I/O interfaces 404 enable the computing system 400 to interact with external peripherals, allowing user input (e.g., via keyboards, touchscreens, or sensors) and system output (e.g., to displays or printers). Depending on the application, these I/O interfaces 404 may also support specialized devices used for maintenance, debugging, or other administrative functions. Meanwhile, the network interface 406 handles connectivity to external networks, which may include the Internet, private networks, or cloud environments. This network interface can be an Ethernet interface or the like. By using secure transport protocols and encryption, data transmitted via the network interface 406 can remain protected, enabling the computing system 400 to participate safely in distributed or cloud-based deployments.

The data store 408 provides storage for both persistent and temporary data. It may include volatile memory (e.g., random access memory (RAM)) for high-speed operations and nonvolatile media (e.g., solid-state drives, hard disk drives, optical media) for long-term retention. In some deployments, the data store 408 may integrate with network-attached storage (NAS), storage area networks (SAN), or cloud-based storage solutions. These configurations can range from modest local setups to large-scale installations, potentially featuring global deduplication, compression, encryption at rest, and multi-site replication. The data store 408 can hold operational logs, configuration details, policy rules, program binaries, and cached computation results.

The memory 410 typically serves as the primary working memory for the processors 402. It may be composed of volatile elements (e.g., dynamic RAM (DRAM), double data rate (DDR), synchronous DRAM (SDRAM)) for fast access, as well as nonvolatile components such as flash memory or non-volatile RAM (NVRAM). The memory 410 can be distributed across nodes or servers to support the large-scale in-memory processing demanded by modern cloud services. Generally, the memory 410 stores the operating system (O/S) 414 and one or more programs 416. The O/S 414 handles core system tasks such as process scheduling, memory allocation, file management, and networking.

Various embodiments may utilize different forms of processing circuitry—general-purpose microprocessors, CPUs, digital signal processors (DSPs), network processors, GPUs, field programmable gate arrays (FPGAs), programmable logic devices (PLDs), or similar. This circuitry may be controlled by software, firmware, or a combination thereof, possibly alongside non-processor circuits to achieve the desired functionality. Specific tasks can also be handled by state machines or one or more application-specific integrated circuits (ASICs) that implement dedicated logic. In some cases, a hybrid approach may be adopted. Additionally, implementations can include a non-transitory computer-readable storage medium that stores computer-readable instructions. When executed by a device containing suitable processing circuitry, these instructions cause the system to perform the methods or algorithms described in this disclosure. Non-limiting examples of such storage media include hard disks, optical disks, magnetic devices, read-only memory (ROM) and its variants, flash memory, or other persistent/semi-persistent storage. Once stored, these instructions enable execution of the disclosed methods.

### Process

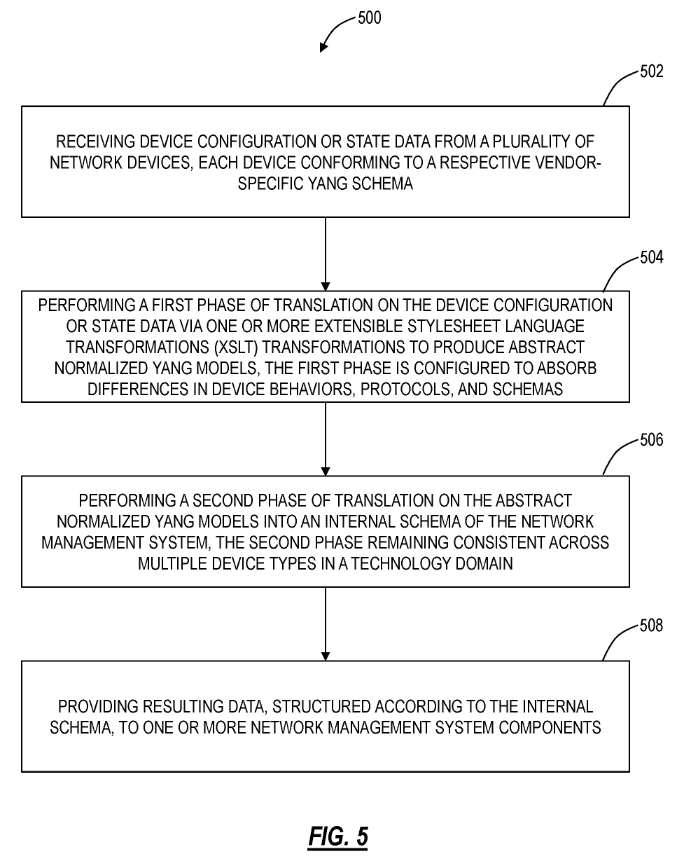

FIG. 5 illustrates a flowchart of a process 500 for integrating heterogeneous network devices into a network management system via a resource adapter. In various embodiments, the process 500 can be implemented in multiple ways: as a method comprising distinct steps, via the computing system 400 configured to execute those steps, or through a non-transitory computer-readable medium that stores instructions causing one or more processors to perform the steps. This flexibility allows process 500 to be adapted to various system architectures and deployment scenarios.

The process 500 includes receiving device configuration or state data from a plurality of network devices, each device conforming to a respective vendor-specific YANG schema (step 502); performing a first phase of translation on the device configuration or state data via one or more extensible stylesheet language transformations (XSLT) transformations to produce abstract normalized YANG models, the first phase is configured to absorb differences in device behaviors, protocols, and schemas (step 504); performing a second phase of translation on the abstract normalized YANG models into an internal schema of the network management system, the second phase remaining consistent across multiple device types in a technology domain (step 506); and providing resulting data, structured according to the internal schema, to one or more network management system components (step 508).

The process 500 can further include dynamically modifying at least one XSLT transformation at runtime, without requiring a system restart, to accommodate changes in device types or feature requirements. The process 500 can further include storing or caching the abstract normalized YANG models before converting them into the internal schema of the network management system. The process 500 can further include validating the device configuration or state data against corresponding YANG schema definitions prior to the first phase of translation, and rejecting or logging any data that does not conform. The process 500 can further include applying one or more rules via a rule engine to dynamically determine which XSLT transformations to invoke for the first phase of translation based on at least one of device type, vendor identifier, software version, or user-defined policies.

The internal schema of the network management system is one of a termination point encapsulation/forwarding relationship encapsulation/network construct/equipment (TPE/FRE/NC/Equipment), a software-defined networking (SDN) controller model, an orchestration system model, or proprietary internal schema. The one or more XSLT transformations include at least one of merging multiple Extensible Markup Language (XML) paths into a single abstract YANG attribute, splitting a single XML path into multiple abstract YANG attributes, executing conditional logic to accommodate device-specific behaviors, or embedding or invoking scripts in a language other than XSLT. The process 500 can further include receiving updates to the XSLT transformations via a Representational State Transfer (REST) application programming interface (API) and instructing the resource adapter to use the updated XSLT transformations without requiring a code patch or system restart.

The process 500 can further include implementing session handlers for multiple management protocols, including at least one of Network Configuration Protocol (NETCONF), gRPC Network Management Interface (gNMI), or a command line interface (CLI), to retrieve the device configuration or state data from each network device. The process 500 can further include publishing only portions of the abstract normalized YANG models or the internal schema data that are relevant to one or more northbound components of the network management system in order to minimize unnecessary data transmission. The process 500 can further include merging information from at least two different protocols, including any of Network Configuration Protocol (NETCONF), gRPC Network Management Interface (gNMI), or a command line interface (CLI), into a single abstract YANG attribute prior to the first phase of translation.

The resource adapter can be deployed in a dedicated Java process that executes both phases of translation and communicates the resulting data to the network management system without sharing hardware resources with other processes. The process 500 can further include providing an option to deliver the abstract normalized YANG models directly to an external operations support system (OSS) or analytics platform, bypassing the second phase of translation for customers desiring device-agnostic data. The process 500 can further include storing workflow definitions and policy rules in one or more repositories to govern how incoming device data is processed and mapped, thereby enabling non-developer stakeholders to configure or override translation behaviors. The process 500 can further include incorporating fallback or error-handling mechanisms that revert to a default XSLT transformation when a custom or newly introduced XSLT file fails to produce valid abstract YANG data, for continuous operation.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for integrating heterogeneous network devices into a network management system via a resource adapter, the method comprising steps of:
receiving device configuration or state data from a plurality of network devices, each device conforming to a respective vendor-specific YANG schema;
performing a first phase of translation on the device configuration or state data via one or more extensible stylesheet language transformations (XSLT) transformations to produce abstract normalized YANG models, the first phase is configured to absorb differences in device behaviors, protocols, and schemas;
performing a second phase of translation on the abstract normalized YANG models into an internal schema of the network management system, the second phase remaining consistent across multiple device types in a technology domain; and
providing resulting data, structured according to the internal schema, to one or more network management system components.

2. The method of claim 1, wherein the steps further include
dynamically modifying at least one XSLT transformation at runtime, without requiring a system restart, to accommodate changes in device types or feature requirements.

3. The method of claim 1, wherein the steps further include
storing or caching the abstract normalized YANG models before converting them into the internal schema of the network management system.

4. The method of claim 1, wherein the steps further include
validating the device configuration or state data against corresponding YANG schema definitions prior to the first phase of translation, and rejecting or logging any data that does not conform.

5. The method of claim 1, wherein the steps further include
applying one or more rules via a rule engine to dynamically determine which XSLT transformations to invoke for the first phase of translation based on at least one of device type, vendor identifier, software version, or user-defined policies.

6. The method of claim 1, wherein the internal schema of the network management system is one of
a termination point encapsulation/forwarding relationship encapsulation/network construct/equipment (TPE/FRE/NC/Equipment) model,
a software-defined networking (SDN) controller model,
an orchestration system model, or
a proprietary internal schema.

7. The method of claim 1, wherein the one or more XSLT transformations include at least one of
merging multiple Extensible Markup Language (XML) paths into a single abstract YANG attribute,
splitting a single XML path into multiple abstract YANG attributes,
executing conditional logic to accommodate device-specific behaviors, or
embedding or invoking scripts in a language other than XSLT.

8. The method of claim 1, wherein the steps further include
receiving updates to the XSLT transformations via an application programming interface (API) and instructing the resource adapter to use the updated XSLT transformations without requiring a code patch or system restart.

9. The method of claim 1, wherein the steps further include
implementing session handlers for multiple management protocols, including at least one of Network Configuration Protocol (NETCONF), gRPC Network Management Interface (gNMI), or a command line interface (CLI), to retrieve the device configuration or state data from each network device.

10. The method of claim 1, wherein the steps further include
publishing only portions of the abstract normalized YANG models or the internal schema data that are relevant to one or more northbound components of the network management system in order to minimize unnecessary data transmission.

11. The method of claim 1, wherein the steps further include
merging information from at least two different protocols, including any of Network Configuration Protocol (NETCONF), gRPC Network Management Interface (gNMI), or a command line interface (CLI), into a single abstract YANG attribute prior to the first phase of translation.

12. The method of claim 1, wherein the resource adapter is deployed in a dedicated Java process that executes both phases of translation and communicates the resulting data to the network management system without sharing hardware resources with other processes.

13. The method of claim 1, wherein the steps further include
providing an option to deliver the abstract normalized YANG models directly to an external operations support system (OSS) or analytics platform, bypassing the second phase of translation for customers desiring device-agnostic data.

14. The method of claim 1, wherein the steps further include
storing workflow definitions and policy rules in one or more repositories to govern how incoming device data is processed and mapped, thereby enabling non-developer stakeholders to configure or override translation behaviors.

15. The method of claim 1, wherein the steps further include
incorporating fallback or error-handling mechanisms that revert to a default XSLT transformation when a custom or newly introduced XSLT file fails to produce valid abstract YANG data, for continuous operation.

16. A non-transitory computer-readable medium storing instructions for integrating heterogeneous network devices into a network management system via a resource adapter, the instructions, when executed, cause one or more processors to perform steps of:
receiving device configuration or state data from a plurality of network devices, each device conforming to a respective vendor-specific YANG schema;
performing a first phase of translation on the device configuration or state data via one or more extensible stylesheet language transformations (XSLT) transformations to produce abstract normalized YANG models, the first phase is configured to absorb differences in device behaviors, protocols, and schemas;
performing a second phase of translation on the abstract normalized YANG models into an internal schema of the network management system, the second phase remaining consistent across multiple device types in a technology domain; and
providing resulting data, structured according to the internal schema, to one or more network management system components.

17. The non-transitory computer-readable medium of claim 16, wherein the steps further include
applying one or more rules via a rule engine to dynamically determine which XSLT transformations to invoke for the first phase of translation based on at least one of device type, vendor identifier, software version, or user-defined policies.

18. The non-transitory computer-readable medium of claim 16, wherein the steps further include
receiving updates to the XSLT transformations via a Representational State Transfer (REST) application programming interface (API) and instructing the resource adapter to use the updated XSLT transformations without requiring a code patch or system restart.

19. The non-transitory computer-readable medium of claim 16, wherein the steps further include
merging information from at least two different protocols, including any of Network Configuration Protocol (NETCONF), gRPC Network Management Interface (gNMI), or a command line interface (CLI), into a single abstract YANG attribute prior to the first phase of translation.

20. A system for integrating heterogeneous network devices into a network management system via a resource adapter, the system comprising:
one or more processors; and
memory storing instructions that, when executed, cause the one or more processors to
receive device configuration or state data from a plurality of network devices, each device conforming to a respective vendor-specific YANG schema,
perform a first phase of translation on the device configuration or state data via one or more extensible stylesheet language transformations (XSLT) transformations to produce abstract normalized YANG models, the first phase is configured to absorb differences in device behaviors, protocols, and schemas,
perform a second phase of translation on the abstract normalized YANG models into an internal schema of the network management system, the second phase remaining consistent across multiple device types in a technology domain, and
provide resulting data, structured according to the internal schema, to one or more network management system components.
